(19) United States
(12) Patent Application Publication
(10) Pub. No.: US 2026/0074819 A1
(43) Pub. Date: Mar. 12, 2026

(54) CIRCUITS AND METHODS FOR PHOTONIC WAVELENGTH DIVISION MULTIPLEXERS

(71) Applicant: WHALEPIX INC., QUEBEC (CA)

(72) Inventors: WEI SHI, QUEBEC (CA); MOHAMMAD AHMADI, OTTAWA (CA); HASSAN SEPEHRIAN, OTTAWA (CA); LUHUA XU, BROSSARD (CA); HENRY FRANKIS, STITTSVILLE (CA)

(21) Appl. No.: 18/807,401

(22) Filed: Aug. 16, 2024

Related U.S. Application Data
(60) Provisional application No. 63/571,651, filed on Mar. 29, 2024.
(60) Provisional application No. 63/657,273, filed on Jun. 7, 2024.

(51) Int. Cl. H04J 14/02

(52) U.S. Cl. CPC H04J 14/0307

(57) ABSTRACT

Photonics has become a dominant or evolving technological solution for communications to meet the increasing demand for bandwidth. Wavelength division multiplexing (WDM) enables an optical fiber to support multiple concurrent optical signals each at a different wavelength. However, fabrication tolerances can impact the performance of these WDM multiplexers and demultiplexers. However, active deployments with active thermal control of the WDM can lead to increased electrical consumption which can increase initial deployment and lifetime operating costs. Accordingly, it would be beneficial if control methodologies and circuits could be established which reduce thermal control power requirements.

### CROSS-REFERENCE TO RELATED APPLICATIONS

This patent application claims the benefit of priority to U.S. Provisional Patent Applications 63/571,651 filed Mar. 29, 2024.

This patent application claims the benefit of priority to U.S. Provisional Patent Applications 63/657,253 filed Jun. 7, 2024.

### FIELD OF THE INVENTION

This invention is directed to photonic circuits for optical networks and more particularly to methods and device structures for tuning coarse wavelength division multiplexers-demultiplexers

### BACKGROUND OF THE INVENTION

Photonics has become a dominant or evolving technological solution in a wide range of applications from sensing, biomedical sensing, to quantum computing, quantum sensing, and telecommunications. Within communications streaming media, mobile data traffic, and cloud computing continue to fuel an increasing demand for bandwidth at reduced costs, both initial costs for the system and its installation and subsequent lifetime operating costs.

Amongst the established and emerging technologies Silicon Photonics is a promising technology for adding integrated optics functionality to integrated circuits or for implementing photonic circuits discretely by leveraging the economies of scale of the CMOS microelectronics industry. Some variants of Silicon Photonics may use other materials as the waveguide core such as silicon nitride (SixNy) and silicon oxynitride (SiOxN1−x) for example. Silicon Photonics in addition to leveraging CMOS based silicon fabrication processes also allows for the integration of control and driver CMOS electronics discretely or in conjunction with microelectromechanical systems (MEMS) elements to provide Micro-Opto-Electro-Mechanical-Systems (MOEMS).

Further, wavelength division multiplexing (WDM) allows an optical fiber to support multiple concurrent optical signals each at a different wavelength. For example, coarse WDM (CWDM) networks support up to 18 wavelengths with a channel spacing of 20 nm over the wavelength range from 1271 nm to 1611 nm with a reach up to 150 km or so. However, fabrication tolerances can impact the performance of the multiplexers and demultiplexers for such CWDM networks such that either where in passive deployments (no active control of the CWDM) reduced yields must be accommodated together with increased component costs or in active deployments (with active thermal control of the CWDM) increased electrical consumption results offsetting reduced initial deployment costs and increasing lifetime operating costs. Accordingly, it would be beneficial to establish control methodologies and circuits that reduce thermal control power requirements where possible.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations in the prior art relating to photonic circuits for optical networks and more particularly to methods and device structures for tuning coarse wavelength division multiplexers-demultiplexers.

In accordance with an embodiment of the invention there is provided a device comprising:
a plurality of cyclic optical wavelength filters (COWFs) disposed in series in a plurality of stages; wherein
each COWF in each stage of the plurality of stages except a last stage of the plurality of stages is coupled to a pair of COWFs within a next stage of the plurality of stages;
the first stage of the plurality of stages coupled to a port for receiving a plurality of wavelength division multiplexed signals on a defined wavelength grid;
each COWF of the plurality of COWFs within a stage of the plurality of stages has a free spectral range (FSR) equal to a predetermined fraction of the FSR of those COWFs within a succeeding stage of the plurality of stages;
a subset of the plurality of stages comprising at least the first stage of the plurality of stages comprise phase shift elements (PSEs) for adjusting a characteristic of the COWFs within the subset of the plurality of stages; and
the COWFs of the plurality of COWFs within the subsequent stages of the plurality of stages to the first stage of the plurality of stages are provisioned independent of PSEs for adjusting the characteristic of the COWFs within the subsequent stages of the plurality of stages to the first stage of the plurality of stages.

In accordance with an embodiment of the invention there is provided a method comprising: providing a plurality of cyclic optical wavelength filters (COWFs) disposed in series in a plurality of stages; wherein
each COWF in each stage of the plurality of stages except a last stage of the plurality of stages is coupled to a pair of COWFs within a next stage of the plurality of stages;
the first stage of the plurality of stages coupled to a port for receiving a plurality of wavelength division multiplexed signals on a defined wavelength grid;
each COWF of the plurality of COWFs within a stage of the plurality of stages has a free spectral range (FSR) equal to a predetermined fraction of the FSR of those COWFs within a succeeding stage of the plurality of stages;
a subset of the plurality of stages comprising at least the first stage of the plurality of stages comprise phase shift elements (PSEs) for adjusting a characteristic of the COWFs within the subset of the plurality of stages; and
the COWFs of the plurality of COWFs within the subsequent stages of the plurality of stages to the first stage of the plurality of stages are provisioned independent of PSEs for adjusting the characteristic of the COWFs within the subsequent stages of the plurality of stages to the first stage of the plurality of stages.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts wavelength demultiplexer (WDMUX) designs exploiting cascaded wavelength filters with different free spectral ranges in each state of the wavelength demultiplexer;

FIG. 2 depicts a WDMUX exploiting passband flattened wavelength filters exploiting cascaded Mach-Zehnder interferometer (MZI) elements;

FIG. 3 depicts a WDMUX exploiting passband flattened wavelength filters exploiting cascaded Mach-Zehnder interferometer (MZI) elements where each stage comprises a WDMUX with additional wavelength filters per output;

FIG. 4 depicts the wavelength output from a WDMUX according to the design depicted in FIG. 3 with the nominal design parameters whilst FIG. 5 depicts the resulting wavelength output from the WDMUX for width and thickness changes away from the nominal design parameters;

FIG. 6A depicts the design approach according to an embodiment of the invention wherein only the initial stage of the WDMUX according to design of FIG. 3 is subjected to temperature control together with a schematic of a circuit design showing the electrical and optical layers;

FIG. 6B depicts the electrical control and heater configuration of a cascaded MZI as employed within embodiments of the invention and design routes to low electrical power consumption for silicon waveguides; and

FIGS. 7A and 7B depict the electrical control paths and phase shifter elements excited under two different activations.

### DETAILED DESCRIPTION

The present invention is directed to photonic circuits for optical networks and more particularly to methods and device structures for tuning coarse wavelength division multiplexers-demultiplexers.

The ensuing description provides representative embodiment(s) only, and is not intended to limit the scope, applicability or configuration of the disclosure. Rather, the ensuing description of the embodiment(s) will provide those skilled in the art with an enabling description for implementing an embodiment or embodiments of the invention. It would be understood by one of skill in the art that various changes can be made in the function and arrangement of elements without departing from the scope of the invention as set forth in the claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment,” “an embodiment,” “some embodiments” or “other embodiments” means that a particular feature, structure, or characteristic described in connection with the embodiments is included in at least one embodiment, but not necessarily all embodiments, of the inventions. The phraseology and terminology employed herein is not to be construed as limiting but is for descriptive purposes only. It is to be understood that where the claims or specification refer to “a” or “an” element, such reference is not to be construed as there being only one of that element. It is to be understood that where the specification states that a component feature, structure, or characteristic “may,” “might,” “can” or “could” be included, that particular component, feature, structure, or characteristic is not required to be included.

Reference to terms such as “left,” “right,” “top,” “bottom”, “front” and “back” are intended for use in respect to the orientation of the particular feature, structure, or element within the figures depicting embodiments of the invention. It would be evident that such directional terminology with respect to the actual use of a device has no specific meaning as the device can be employed in a multiplicity of orientations by the user or users.

Reference to terms “including,” “comprising,” “consisting” and grammatical variants thereof do not preclude the addition of one or more components, features, steps, integers or groups thereof and that the terms are not to be construed as specifying components, features, steps or integers. Likewise, the phrase “consisting essentially of,” and grammatical variants thereof, when used herein is not to be construed as excluding additional components, steps, features integers or groups thereof but rather that the additional features, integers, steps, components or groups thereof do not materially alter the basic and novel characteristics of the claimed composition, device or method. If the specification or claims refer to “an additional” element, that does not preclude there being more than one of the additional elements.

A “two-dimensional” waveguide, also referred to as a 2D waveguide or a planar waveguide, as used herein may refer to, but is not limited to, an optical waveguide supporting propagation of optical signals within a predetermined wavelength range which does not guide the optical signals laterally relative to the propagation direction of the optical signals.

A “three-dimensional” waveguide, also referred to as a 3D waveguide, a channel waveguide, or simply waveguide as used herein may refer to, but is not limited to, an optical waveguide supporting propagation of optical signals within a predetermined wavelength range which guides the optical signals laterally relative to the propagation direction of the optical signals.

A “photonic integrated circuit” (PIC) as used herein may refer to, but is not limited to, the monolithic integration of multiple integrated optics devices into a circuit formed upon a common substrate providing an optical routing and processing functionality. The PIC is fabricated using processing techniques at a wafer level, e.g., CMOS manufacturing flows, MEMS processing flows, etc.

An “adiabatic coupler” as used herein may refer to, but is not limited to, an optical coupler which adiabatically converts the mode of an input optical waveguide into either the even or odd mode of two or more optical waveguides separated by small gap(s). An adiabatic coupler may therefore be a non-zero gap symmetric directional coupler or a non-zero gap asymmetric directional coupler for example.

Within embodiments of the invention the inventors may refer to the term “hybridly integrated.” This may, within some embodiments of the invention, refer to, but not be limited to, the “integration” of an optical element onto a substrate by attaching the optical element or another element physically integrated with the optical element to the substrate (platform) such that the optical element is retained in position. Such attachment means may include, but not be limited to, soldering, epoxy, van der Waals forces, electrostatic attachment, magnetic attachment, physical interlocking and friction. Accordingly, in these embodiments of the invention the optical element being hybridly integrated may be viewed as being implemented within a parallel manufacturing process to the other optical element(s) prior to being co-assembled. This parallel manufacturing process may employ one or more processes selected from the group comprising, but not limited to, liquid phase epitaxy (LPE), metal organic chemical vapor deposition (MOCVD), organometallic vapour-phase epitaxy (OMVPE), selective area epitaxy, an additive manufacturing process, a non-additive manufacturing process, crystal growth, doping, induced damage, etching, doping and deposition.

This may, within other embodiments of the invention, refer to, but not be limited to, the “integration” of an optical element onto a substrate using a different manufacturing methodology and/or techniques to those employed in forming other optical components upon the substrate. For example, this may employ employing a LPE process to form the other optical element upon the substate wherein the optical component upon the substrate was formed by MOCVD or vice-versa. Alternatively, both the optical component and other optical component may be formed using the same manufacturing methodology or a combination of manufacturing methodologies. These manufacturing methodologies may employ one or more processes selected from the group comprising, but not limited to, LPE, MOCVD, OMVPE, selective area epitaxy, an additive manufacturing process, a subtractive manufacturing process, a non-additive manufacturing process, crystal growth, doping, induced damage, etching, doping, and deposition Within the embodiments of the invention the inventors refer to the terms “hybridly integrated” and “hybrid integration.” This may, within some embodiments of the invention, refer to, but not be limited to, the “integration” of an optical element onto a substrate by attaching the optical element or another element physically integrated with the optical element to the substrate (platform) such that the optical element is retained in position. Such attachment means may include, but not be limited to, soldering, epoxy, van der Waals forces, electrostatic attachment, magnetic attachment, physical interlocking and friction. Accordingly, in these embodiments of the invention the optical element being hybridly integrated may be viewed as being implemented within a parallel manufacturing process to the other optical element(s) prior to being co-assembled. This parallel manufacturing process may employ one or more processes selected from the group comprising, but not limited to, liquid phase epitaxy (LPE), metal organic chemical vapor deposition (MOCVD), organometallic vapour-phase epitaxy (OMVPE), selective area epitaxy, an additive manufacturing process, a non-additive manufacturing process, crystal growth, doping, induced damage, etching, doping and deposition.

Within the embodiments of the invention the inventors refer to the terms “monolithically integrated” and “monolithic integration.” This may, within some embodiments of the invention, refer to, but not be limited to, the “integration” of an optical element onto a substrate by directly forming the optical element upon a substrate (platform). The optical element may be one of a series of optical elements formed upon the substrate to form an optical component or optical circuit. These optical elements may be optical waveguides themselves, be interconnected by optical waveguides, be interconnected by other optical elements formed upon the substrate through a subsequent processing step or stage or interconnected via other optical elements hybridly integrated onto the substrate. Accordingly, these monolithically integrated optical elements, e.g. optical waveguides, in these embodiments of the invention may employ one or more manufacturing processes selected from the group comprising, but not limited to, liquid phase epitaxy (LPE), metal organic chemical vapor deposition (MOCVD), organometallic vapour-phase epitaxy (OMVPE), selective area epitaxy, photolithography, direct writing, ion beam milling, an additive manufacturing process, a non-additive manufacturing process, crystal growth, doping, induced damage, chemical etching, reactive ion etching (RIE), plasma etching, sputter etching, ion beam assisted etching, reactive ion beam etching, lift-off and deposition.

A “ceramic” as used herein may refer to, but is not limited to, an inorganic, nonmetallic solid material comprising metal, non-metal or metalloid atoms primarily held in ionic and covalent bonds. Such ceramics may be crystalline materials such as oxide, nitride or carbide materials, elements such as carbon or silicon, and non-crystalline. Exemplary ceramics may include high temperature ceramics or high temperature co-fired ceramics such as alumina (Al2O3), zirconia (ZrO2), and aluminum nitride (AlN) or a low temperature cofired ceramic (LTCC). A LTCC may be formed from a glass—ceramic combination.

A “metal” or “alloy” as used herein may refer to, but is not limited to, a material having good electrical and thermal conductivity. Metals are generally malleable, fusible, and ductile. Metals as used herein may refer to elements such as gold, silver, copper, aluminum, iron, etc. whilst an alloy as used herein refers to a combination of metals such as bronze, stainless steel, steel etc.

A “polymer” as used herein may refer to, but is not limited to, is a large molecule, or macromolecule, composed of many repeated subunits. Such polymers may be natural and synthetic and typically created via polymerization of multiple monomers. Polymers through their large molecular mass may provide unique physical properties, including toughness, viscoelasticity, and a tendency to form glasses and semi-crystalline structures rather than crystals.

A “glass” as used herein may refer to, but is not limited to, a non-crystalline amorphous solid. A glass may be fused quartz, silica, a soda-lime glass, a borosilicate glass, a lead glass, an aluminosilicate glass for example. A glass may include other inorganic and organic materials including metals, aluminates, phosphates, borates, chalcogenides, fluorides, germanates (glasses based on GeO2), tellurites (glasses based on TeO2), antimonates (glasses based on Sb2O3), arsenates (glasses based on As2O3), titanates (glasses based on TiO2), tantalates (glasses based on Ta2O5), nitrates, carbonates, plastics, and an acrylic.

A “cyclic” wavelength division multiplexer (WMUX) as used herein may refer to, but is not limited to, a WMUX having a free spectral range (FSR) such that the filtering characteristic of the cyclic WMUX repeats across the wavelength range with the FSR. For example, the FSR may be 50 GHz, 100 GHz, 200 GHz etc. for dense wavelength division multiplexing (WDM) systems or it may be 10 nm, 20 nm, 40 nm, etc. for coarse WDM systems. The cyclic WMUX combining optical signals on multiple inputs to a common output. A cyclic wavelength division demultiplexer (WDMUX) is a WMUX operated in reverse such that signals on a common input are split to multiple outputs.

Embodiments of the invention may be implemented within one or more semiconductor materials (semiconductors), grown for example through LPE, MOCVD or OMVPE. The one or more semiconductors may include, but are not limited to, group III-V semiconductors, II-VI semiconductors, group IV semiconductors, and group IV-V-VI semiconductors. Examples of group III-V semiconductors may include AlP, AlN, AlGaSb, AlGaAs, AlGaInP, AlGaN, AlGaP, GaSb, GaAsP, GaAs, GaN, GaP, InAlAs, InAlP, InSb, InGaSb, InGaN, GaInAlAs, GaInAlN, GaInAsN, GaInAsP, GaInAs, GaInP, InN, InP, InAs, InAsSb, InGaAsP and AlInN. Examples of group II-VI semiconductors may include ZnSe, HgCdTe, ZnO, ZnS, and CdO. Examples of group IV Semiconductors may include Si, Ge, and strained silicon. A group IV-V-VI semiconductor may be GeSbTe.

Such semiconductors in many instances allowing monolithic integration of passive optical waveguides with active optical elements such as light emitting diodes, semiconductor optical amplifiers, laser diodes (LDs), distributed feedback LDs, external cavity laser diodes (ECLs), photodetectors (PDs) and avalanche photodetectors (APDs). For example, InGaAsP semiconductors support PDs/LDs/ECLs etc. operating in the conventional infrared telecommunication windows known as S-band (1460-1530 nm), C-band (1530-1565 nm) and L-band (1565-1625 nm).

Within embodiments of the invention the platform or substrate upon which the semiconductors are grown and processed may itself be a semiconductor, e.g., GaAs or InP, or it may within other embodiments of the invention be another material such as silicon, germanium, a ceramic, a glass and a polymer.

Within embodiments of the invention the platform or substrate upon which the integration is performed may be a silicon substrate wherein the one or more optical waveguides upon the platform exploit a silicon nitride core with silicon oxide upper and lower cladding, a waveguide structure. Alternatively, the one or more optical waveguides may employ a silicon core with silicon nitride upper and lower claddings. Optionally, the upper cladding may be omitted within other embodiments of the invention.

Embodiments of the invention may be implemented within one or more silicon-on-insulator (SOI) waveguides by way of example, e.g. air-clad Si₃N₄—SiO₂, SiO₂—Si₃N₄—SiO₂, SiO₂—¿:SiO₂—SiO₂ or Si—SiO₂. Embodiments of the invention may be implemented with one or more waveguides such as ion exchanged glass waveguides, ion implanted glass waveguides, polymer-on-silicon waveguides, doped silicon waveguides and polymeric waveguides. Whilst not necessarily leveraging the benefits of photonic integration embodiments of the invention may also be formed using optical fibers, free-space optics, etc.

Where passive optical waveguides are employed with hybrid integration of active photonic elements, such as LDs, ECLs, PDs then these may be directly butt-coupled or they may employ intermediate coupling optics, e.g., ball lenses, spherical lenses, graded refractive index (GRIN) lenses etc. for free-space coupling and/or photonic wirebonds etc. Other waveguide structures may be employed including vertical and/or lateral waveguide tapers and forming microball lenses on the ends of the waveguides via laser and/or arc melting of the waveguide tip.

Embodiments of the invention employing optical waveguides may employ a waveguide core embedded within upper and lower claddings, a so-called buried waveguide, an air clad waveguide (i.e. a core with lower cladding and air elsewhere), a rib waveguide, a diffused waveguide, a ridge or wire waveguide, a strip-loaded waveguide, a slot waveguide, an anti-resonant reflecting optical waveguide (ARROW waveguide), a photonic crystal waveguide, a suspended waveguide, an alternating layer stack geometry, a sub-wavelength grating (SWG) waveguides or an augmented waveguide (e.g. Si—SiO₂-Polymer). Embodiments of the invention may employ a step index waveguide, a graded index waveguide or a hybrid index waveguide (such as combining inverse-step index and graded index).

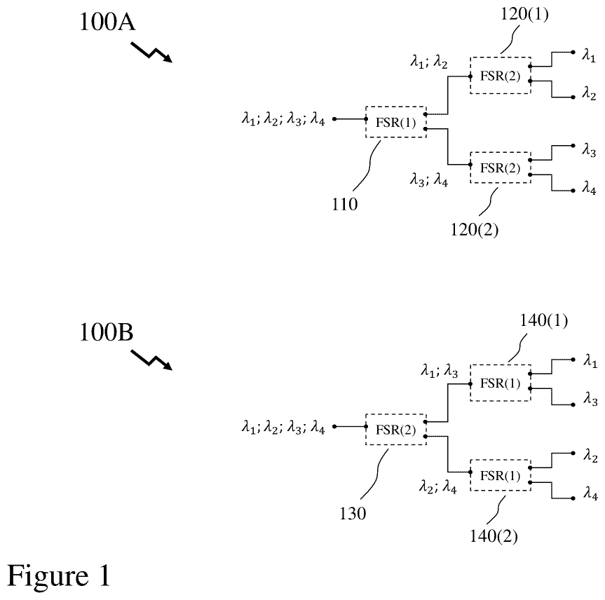

FIG. 1 depicts design schematics of first and second wavelength demultiplexers (WDMUX) 100A and 100B exploiting cascaded wavelength filters with different free spectral ranges in each state of the wavelength demultiplexer. In first WDMUX 100A the input optical stream, denoted as λ₁; λ₂; λ₃; λ₄, is coupled to a first cyclic WDMUX 110 which has a first filtering characteristic of FSR(1) such that the signals λ₁; λ₂ are coupled to the first second cyclic WDMUX 120(1) and the other signals λ₃; λ₄ are coupled to the second second cyclic WDMUX 120(2). Each of the first and second second cyclic WDMUX 120(1) and 120(2) have an FSR(2) such that the signals λ₁; λ₂ coupled to the first cyclic WDMUX 120(1) are split to λ₁ and λ₂ on different output ports whilst the signals λ₃; λ₄ coupled to the second cyclic WDMUX 120(2) are split to λ₃ and λ₄ on different outputs. Accordingly, within typical embodiments FSR(1)=2*FSR(2) .

In second WDMUX 100B the input optical stream, denoted as λ₁; λ₂; λ₃; λ₄, is coupled to a first cyclic WDMUX 130 which has a first filtering characteristic of FSR(2) such that the signals λ₁; λ₃ are coupled to the first second cyclic WDMUX 140(1) and the other signals λ₂; λ₄ are coupled to the second second cyclic WDMUX 140(2). Each of the first and second second cyclic WDMUX 140(1) and 140(2) have an FSR(1) such that the signals λ₁; λ₃ coupled to the first cyclic WDMUX 140(1) are split to λ₁ and λ₃ on different output ports whilst the signals λ₂; λ₄ coupled to the second cyclic WDMUX 140(2) are split to λ₂ and λ₄ on different outputs. Accordingly, within typical embodiments FSR(1)=0.5*FSR(1).

Whilst the output sequence of the second WDMUX 100B is now non-sequential the circuit has the significant benefit that it employs reduced numbers of cyclic WDMUX elements with the smaller FSR relative to the WDMUX 100A. As depicted the number of FSR(2) elements is reduced to 1 from 2 and the benefit increases with the size of the WDMUX. Accordingly, the number of components with small FSR and tighter manufacturing tolerances is reduced.

Within an embodiment of the invention each of the cyclic DMUX may be a simple Mach-Zehnder interferometer (MZI) yielding a sinusoidal wavelength filtering characteristic. However, this yields a high insertion loss variation with frequency from the peak such that the insertion loss of the filter for a wide range of input wavelengths is specified higher. Further, as selecting lasers reduces yields and increases costs the cost driver within systems is to wider passbands such that the loss variation of a simple MZI is significant. Accordingly, the simple single stage MZI is replaced with a multiple stage MZI such that the resulting passband characteristic is flatter, referred to as passband flattened, such that loss variations with wavelength are reduced albeit at the cost of complexity and some overall insertion loss increase.

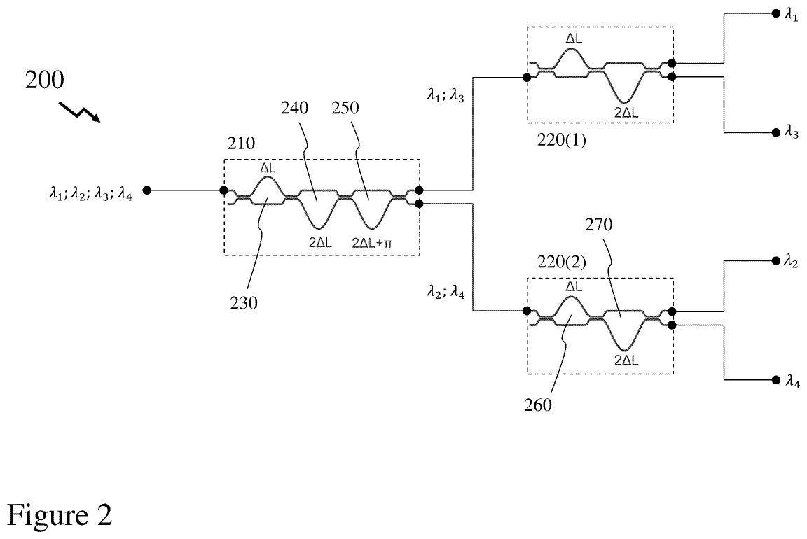

Accordingly, referring to FIG. 2, there is depicted a WDMUX 200 exploiting passband flattened wavelength filters which employ cascaded Mach-Zehnder interferometer (MZI) elements. As depicted the first cyclic WDMUX 210 is a three-stage MZI cascade with first to third MZI 230-250 with path length imbalances of ΔL, 2ΔL; 2ΔL+π respectively where L is established in dependence upon the FSR of the first cyclic WDMUX 210. The outputs from the first cyclic WDMUX 210 are coupled to first and second second cyclic WDMUX 220(1) and 220(2), respectively. Each of these being a dual-stage MZI cascade with fourth and fifth MZI 260 and 270 with path length imbalances of ΔL ; 2ΔL respectively where L is established in dependence upon the FSR of the first and second second cyclic WDMUX 220(1) and 220(2), respectively.

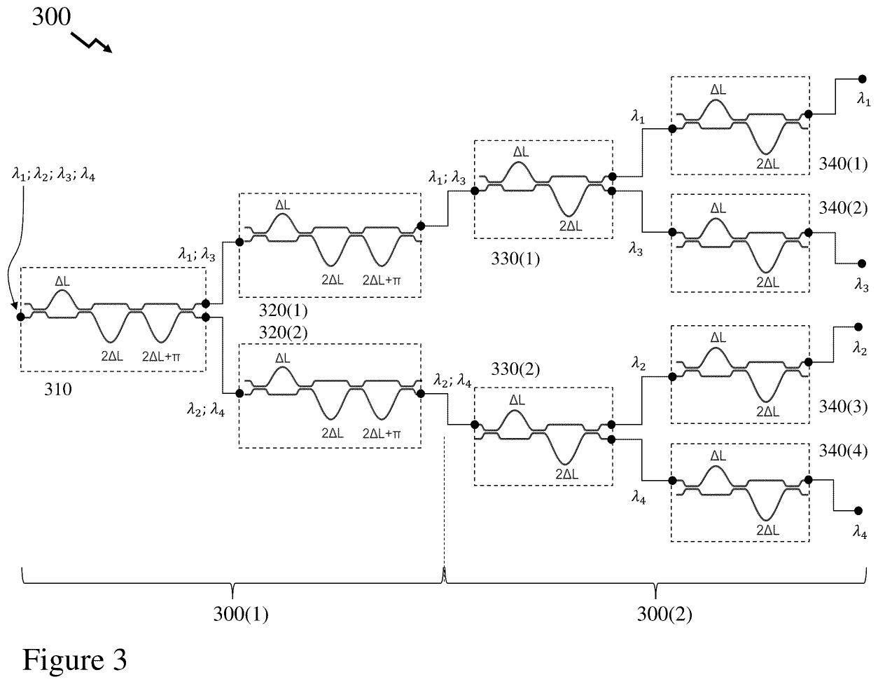

Whilst the passband flattened cyclic WDMUX improves the passband characteristics manufacturing variations, whilst having less impact on the peak of the passband, still impact crosstalk performance of the WDMUX elements. Accordingly, the inventors as depicted in FIG. 3 whilst exploiting passband flattened wavelength filters exploiting cascaded Mach-Zehnder interferometer (MZI) elements within a multi-stage WDMUX design each stage such that it comprises a WDMUX with additional wavelength filters per output. Accordingly, WDMUX 300 comprises a first Stage 300(1) and a second Stage 300(2). The first Stage 300(1) comprising a first cyclic WDMUX 310, equivalent to first cyclic WDMUX 210 in FIG. 2, where each output is then coupled to one of first and second first Filters 320(1) and 320(2) which are equivalent in design to the first cyclic WDMUX 310 and therein first cyclic WDMUX 210 in FIG. 2. Accordingly, each of the first cyclic WDMUX 310 and first and second first Filters 320(1) and 320(2) respectively having an FSR(2) as depicted in second WDMUX 100B in FIG. 1.

The second Stage 300(2) comprises first and second second cyclic WDMUX 330(1) and 330(2), equivalent to first and second second cyclic WDMUX 220(1) and 220(2) in FIG. 2, where each output is then coupled to one of first to fourth second Filters 340(1) to 340(4) which are equivalent in design to the first and second second cyclic WDMUX 330(1) and 330(2) and therein first and second second cyclic WDMUX 220(1) and 220(2) in FIG. 2. Accordingly, each of the first and second second cyclic WDMUX 330(1) and 330(2) and the first to fourth second Filters 330(1) to 340(4) respectively having an FSR(1) as depicted in second WDMUX 100B in FIG. 1 where FSR(1)=0.5*FSR(1).

Whilst the design and fabrication complexity are increased the combination of WDMUX with subsequent filtering per stage improves the overall crosstalk performance of the WDDMUX 300.

It would be evident that the design concepts of FIGS. 1 to 3 can be extended by adding additional stages such that the devices can demultiplex 8, 16, 32 etc. when fully populated or other channel counts (channel plans) when partially populated.

It would be evident that the design concept FIG. 3 wherein the first and second first Filters 320(1) and 320(2) respectively and the first to fourth second Filters 340(1) to 340(4) respectively whilst depicted as 2×2 MZIs may also be 1×2 MZIs or 1×1 MZIs without departing from the scope of the invention.

It would be evident that the design concept FIG. 3 wherein a first Stage 300(1) comprises additional filtering via the first and second first Filters 320(1) and 320(2) respectively as well as the second Stage 300(2) via the first to fourth second Filters 340(1) to 340(4) that within other embodiments of the invention only some stages may comprise the additional filtering, for example, those with the lowest FSR or those with highest FSR as determined from modelling and simulation of the WDDMUX for the nominal design and manufacturing tolerances with the aim of reducing WDDMUX complexity and footprint without degrading performance under manufacturing tolerances.

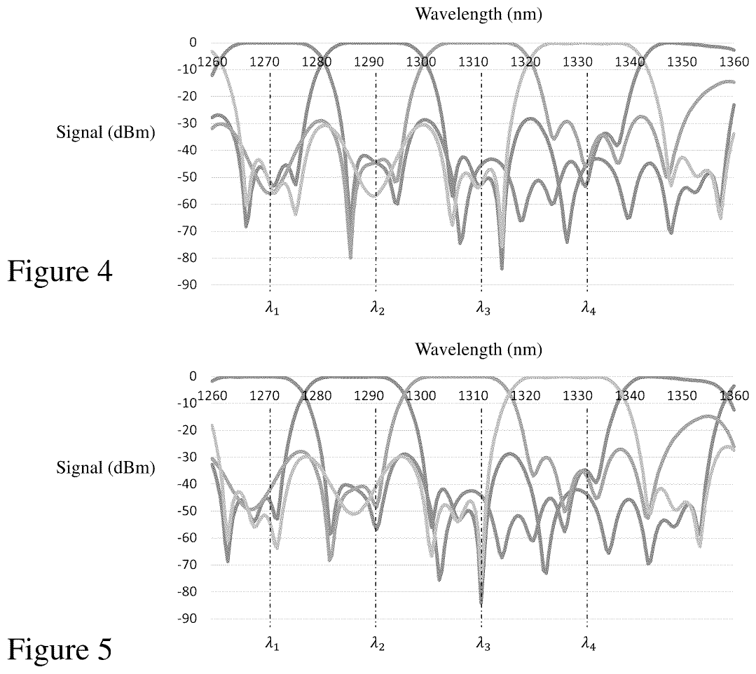

The simulated wavelength output from a WDMUX according to the design depicted in FIG. 3 with the nominal design is depicted in FIG. 4 for the 4-channels at 1271 nm, 1291 nm, 1311 nm and 1331 nm, respectively. FIG. 5 depicts the resulting wavelength output from the WDMUX for width and thickness changes away from the nominal design parameters wherein the waveguide thickness is reduced by 10 nm and the waveguide width by 20 nm. The result is a shift in the wavelength response of approximately 3.7 nm to the blue. Accordingly, it is evident that the design no longer meets the target performance parameters. This can be addressed by adding thermal tuning to recenter the wavelengths of the WDMUX elements to the designed target wavelength.

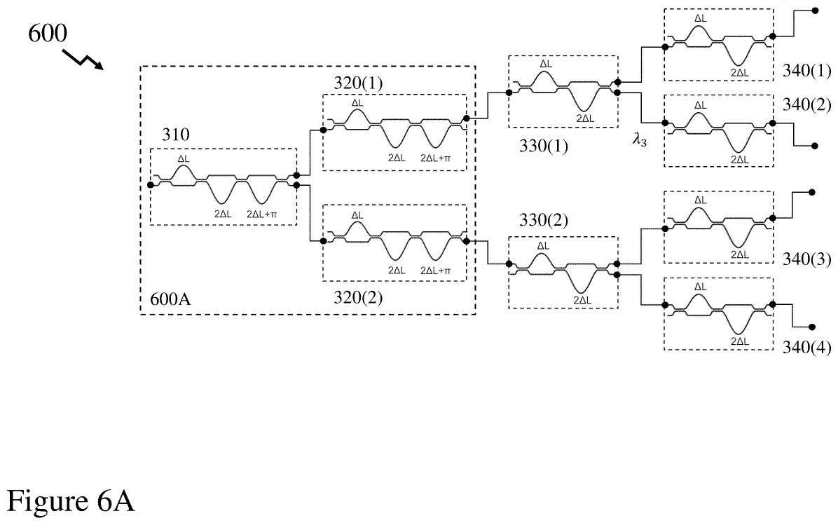

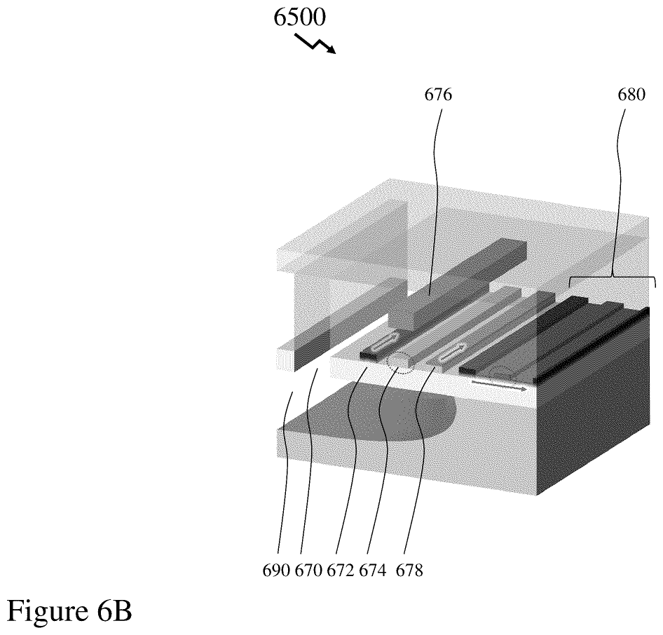

Within the prior art DMUX designs either the entire substrate temperature is adjusted or all elements within the DMUX are controlled. However, the inventors have established that the WDMUX can be re-tuned to the correct wavelengths solely by controlling the first stage, namely the first Stage 300(1) in FIG. 3, that with the lowest FSR. The result depicted in first Image 600 in FIG. 6A is that only the first Stage 600A comprising first cyclic WDMUX 310 and first and second first Filters 320(1) and 320(2) is controlled. As lower electrical power for thermal tuning is required by thermal heaters directly heating the waveguides than the heating the substrate.

The actual design of the heater implemented will vary according to the optical waveguide technology employed as well for some optical waveguide technologies different heater geometries may be implemented upon a common optical waveguide technology. For example, with respect to silicon-on-insulator waveguides then as depicted in second Image 6500 in FIG. 6B the heater elements of the MZIs may be implemented with or as:
reduced heater power through increased thermal isolation of the waveguide section with heater from the substrate via an Undercut 690 wherein the silicon substrate is etched beneath the buried oxide (insulator of the silicon-on-insulator waveguide geometry);
an insulation Trench 670 to improve thermal isolation between elements;
a Doped Silicon Waveguide 672 section;
a Waveguide 674 with Embedded Conductor 676 above embedded in an upper cladding, e.g., a tungsten element for the Embedded Conductor 676;
a Silicon Waveguide with Ni-Silicide 678; and
a back-end Stack 680 with metallization, e.g., copper, and passivation wherein current flows laterally with respect to the waveguide rather than longitudinally with respect to the waveguide.

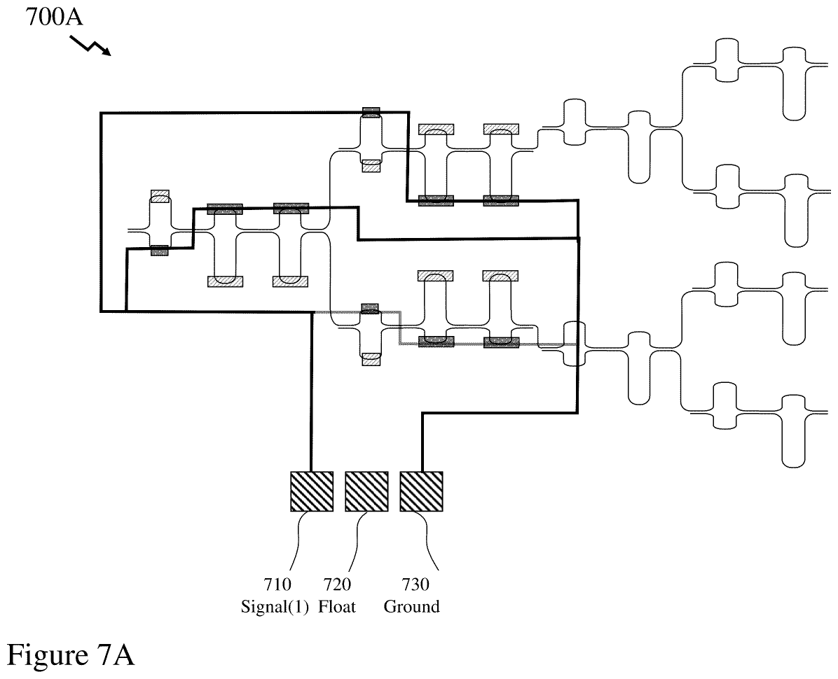

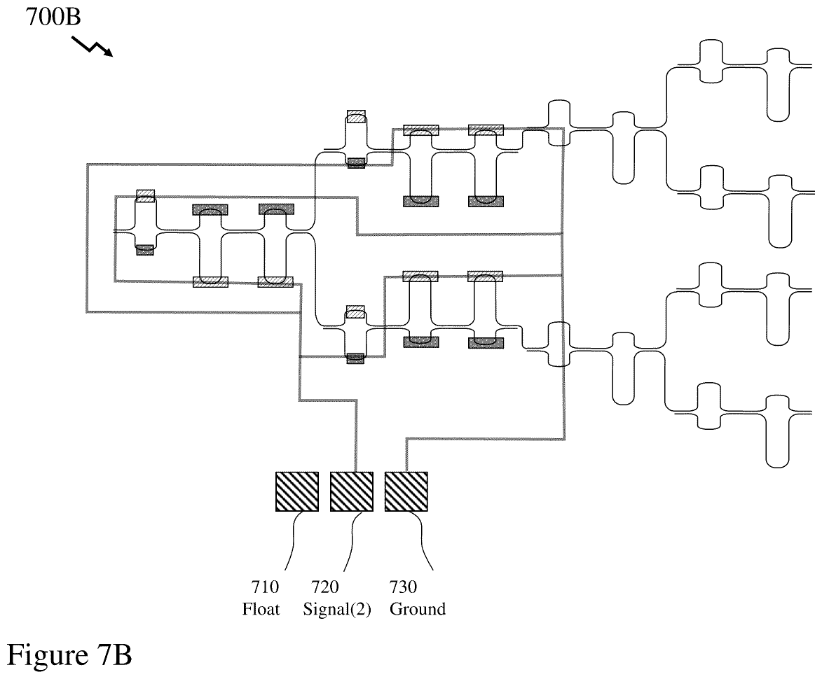

FIGS. 7A and 7B depict the electrical control paths and phase shifter elements excited under two different activations. In FIG. 7A the first to third Electrode Pads 710-730 are configured as Signal(1), Float and Ground respectively for the first activation and Float, Signal(2) and Ground respectively for the second activation. Accordingly, through the interconnections one set of phase shifter elements for each MZI, e.g. the first MZI 610, equivalent to first MZI 230 in FIG. 2, a second MZI 630, equivalent to second MZI 240 in FIG. 2, and third MZI 650, equivalent to third MZI 250 in FIG. 2, are activated under application of Signal(1) in the first activation of FIG. 7A and the other set of phase shifter elements for each MZI are activated under application of Signal(2) in the second activation of FIG. 7B. One activation applying a phase shift to one defined arm of each MZI such that is equivalent to a blue shift of the MZI whilst the other applying a phase shift to the other arm of each MZI such that is equivalent to a red shift of the MZI. Accordingly, simplified control is provided.

It would be evident that the design depicted in FIG. 6B depicts a single heater design for each arm of each of the MZI. However, within other embodiments of the invention the heater design for some MZIs may be different to others within the WDDMUX, such that for example, the heater design is extended for an MZI of FSR(X) relative to that of an MZI of FSR(Y) such that a larger effective phase shift is applied for the MZIs with FSR(X) than FSR(Y) where for example FSR(X)>FSR(Y). The heater design within embodiments of the invention for an MZI may be established in dependence upon the FSR of the stage of the WDDMUX the MZI forms part of.

It would be evident to one of skill in the art that within other embodiments of the invention alternate techniques may be employed to effect a phase shift discretely or in combination with other effects which may include thermos-optic effect via heater(s). Such elements being referred to generally as phase shift elements (PSEs) within the specification. Such techniques may exploit, but not be limited to, mechanical adjustments of the optical path via microelectromechanical systems actuator(s) for example, electro-optic effects including, but not limited to, Pockels effect (linear electro-optic effect), Kerr effect (quadratic electro-optic effect), and current injection. Within other embodiments of the invention optical non-linearities may be exploited to provide optical control of the phase shift discretely or in combination with electrical control.

It would be evident to one of skill in the art that the wavelength division demultiplexer described and depicted with respect to FIGS. 1 to 7B may be operated in reverse as wavelength multiplexers.

It would be evident to one of skill in the art that whilst the photonic circuits described and depicted with respect to FIGS. 1 to 7B employ MZI elements that other wavelength dependent splitters providing cyclic filtering may be employed without departing from the scope of the invention.

It would be evident that whilst the design depicted in FIGS. 2 to 7B exploits the cascaded geometry depicted in second Image 100B that the principle may be applied to the cascaded geometry depicted in first Image 100A wherein the heaters are employed on the cyclic WDMUX with the lowest FSR, i.e., those in the final stage before the outputs.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A device comprising:
a plurality of cyclic optical wavelength filters (COWFs) disposed in series in a plurality of stages; wherein
each COWF in each stage of the plurality of stages except a last stage of the plurality of stages is coupled to a pair of COWFs within a next stage of the plurality of stages;
the first stage of the plurality of stages coupled to a port for receiving a plurality of wavelength division multiplexed signals on a defined wavelength grid;
each COWF of the plurality of COWFs within a stage of the plurality of stages has a free spectral range (FSR) equal to a predetermined fraction of the FSR of those COWFs within a succeeding stage of the plurality of stages;
a subset of the plurality of stages comprising at least the first stage of the plurality of stages comprise phase shift elements (PSEs) for adjusting a characteristic of the COWFs within the subset of the plurality of stages; and
the COWFs of the plurality of COWFs within the subsequent stages of the plurality of stages to the first stage of the plurality of stages are provisioned independent of PSEs for adjusting the characteristic of the COWFs within the subsequent stages of the plurality of stages to the first stage of the plurality of stages.

2. The device according to claim 1, wherein
each COWF of the plurality of COWFs comprises:
a first passband flattened Mach-Zehnder interferometer (MZI) with an FSR defined by the stage of the plurality of stages associated with the COWF of the plurality of COWFs; and
a pair of second passband flattened MZIs each with the FSR defined by the stage of the plurality of stages associated with the COWF of the plurality of COWFs where each second passband flattened MZI of the pair of second passband flattened MZIs is coupled to an output of the first passband flattened MZI.

3. The device according to claim 1, wherein
each COWF of the plurality of COWFs with a subset of the plurality of stages comprises:
a first passband flattened Mach-Zehnder interferometer (MZI) with an FSR defined by the stage of the plurality of stages associated with the COWF of the plurality of COWFs; and
a pair of second passband flattened MZIs each with the FSR defined by the stage of the plurality of stages associated with the COWF of the plurality of COWFs where each second passband flattened MZI of the pair of second passband flattened MZIs is coupled to an output of the first passband flattened MZI; and
the subset of the plurality of stages are those having either an FSR below a defined value or above a defined value.

4. The device according to claim 1, wherein
each COWF within the subset of the plurality of stages comprise a Mach-Zehnder interferometer (MZI); and
the PSEs for adjusting a characteristic of the COWFs within the subset of the plurality of stages comprise a first PSE upon an arm of the MZI and a second PSE upon another arm of the MZI;
the first PSE and second PSE are the same within each COWF with subset of the plurality of stages; and
the first PSE and second PSE are the same within each COWF with each stage of the subset of the plurality of stages.

5. The device according to claim 1, wherein
each COWF within the subset of the plurality of stages comprise a Mach-Zehnder interferometer (MZI); and
the PSEs for adjusting a characteristic of the COWFs within the subset of the plurality of stages comprise a first PSE upon an arm of the MZI and a second PSE upon another arm of the MZI;
the first PSE and second PSE within each COWF of a stage of the subset of the plurality of stages are the same;
the first PSE and second PSE within each COWF within a stage of the subset of the plurality of stages are established in dependence upon the FSR of that stage of the plurality of stages.

6. A method comprising:
providing a plurality of cyclic optical wavelength filters (COWFs) disposed in series in a plurality of stages; wherein
each COWF in each stage of the plurality of stages except a last stage of the plurality of stages is coupled to a pair of COWFs within a next stage of the plurality of stages;
the first stage of the plurality of stages coupled to a port for receiving a plurality of wavelength division multiplexed signals on a defined wavelength grid;
each COWF of the plurality of COWFs within a stage of the plurality of stages has a free spectral range (FSR) equal to a predetermined fraction of the FSR of those COWFs within a succeeding stage of the plurality of stages;
a subset of the plurality of stages comprising at least the first stage of the plurality of stages comprise phase shift elements (PSEs) for adjusting a characteristic of the COWFs within the subset of the plurality of stages; and
the COWFs of the plurality of COWFs within the subsequent stages of the plurality of stages to the first stage of the plurality of stages are provisioned independent of PSEs for adjusting the characteristic of the COWFs within the subsequent stages of the plurality of stages to the first stage of the plurality of stages.

7. The method according to claim 6, wherein
each COWF of the plurality of COWFs comprises:
a first passband flattened Mach-Zehnder interferometer (MZI) with an FSR defined by the stage of the plurality of stages associated with the COWF of the plurality of COWFs; and
a pair of second passband flattened MZIs each with the FSR defined by the stage of the plurality of stages associated with the COWF of the plurality of COWFs where each second passband flattened MZI of the pair of second passband flattened MZIs is coupled to an output of the first passband flattened MZI.

8. The method according to claim 6, wherein
each COWF of the plurality of COWFs with a subset of the plurality of stages comprises:
a first passband flattened Mach-Zehnder interferometer (MZI) with an FSR defined by the stage of the plurality of stages associated with the COWF of the plurality of COWFs; and
a pair of second passband flattened MZIs each with the FSR defined by the stage of the plurality of stages associated with the COWF of the plurality of COWFs where each second passband flattened MZI of the pair of second passband flattened MZIs is coupled to an output of the first passband flattened MZI; and
the subset of the plurality of stages are those having either an FSR below a defined value or above a defined value.

9. The method according to claim 6, wherein
each COWF within the subset of the plurality of stages comprise a Mach-Zehnder interferometer (MZI); and
the PSEs for adjusting a characteristic of the COWFs within the subset of the plurality of stages comprise a first PSE upon an arm of the MZI and a second PSE upon another arm of the MZI;
the first PSE and second PSE are the same within each COWF with subset of the plurality of stages; and
the first PSE and second PSE are the same within each COWF with each stage of the subset of the plurality of stages.

10. The method according to claim 6, wherein
each COWF within the subset of the plurality of stages comprise a Mach-Zehnder interferometer (MZI); and
the PSEs for adjusting a characteristic of the COWFs within the subset of the plurality of stages comprise a first PSE upon an arm of the MZI and a second PSE upon another arm of the MZI;
the first PSE and second PSE within each COWF of a stage of the subset of the plurality of stages are the same;
the first PSE and second PSE within each COWF within a stage of the subset of the plurality of stages are established in dependence upon the FSR of that stage of the plurality of stages.
